(19) United States
(12) Patent Application Publication
(10) Pub. No.: US 2026/0168178 A1
(43) Pub. Date: Jun. 18, 2026

(54) System and Method for Processing Planar Materials into Molded Structures

(71) Applicant: Jacob Joshua Poffenroth, Rocky View (CA)

(72) Inventor: Jacob Joshua Poffenroth, Rocky View (CA)

(21) Appl. No.: 18/983,425

(22) Filed: Dec. 17, 2024

(51) Int. Cl. D21J 3/00; B29C 43/02; B29C 43/58

(52) U.S. Cl. CPC D21J 3/00; B29C 43/02; B29C 43/58

(57) ABSTRACT

A system for processing planar materials into molded structures includes a feeder mechanism configured to align and dispense planar material elements, a manipulator assembly with a multi-axis robotic arm and gripping mechanism to arrange the elements, and a mold assembly with a press mechanism for shaping and compressing the elements. An adhesive dispensing assembly applies adhesive to the elements prior to or during molding, and a curing assembly solidifies the adhesive using heat, light, or ultrasonic energy. A control system coordinates the operation of these components to automate the production of molded structures. The system is adaptable to various planar material types, adhesives, and curing methods, enabling efficient and precise manufacturing processes.

### FIELD OF INVENTION

The present invention relates to automated manufacturing systems, specifically to systems and methods for processing planar material elements, such as playing cards, into molded structures using robotic manipulation, adhesive application, and curing technologies.

### BACKGROUND

The widespread use of playing cards in the gaming and entertainment industries has led to significant concerns about waste management and sustainability. Playing cards, particularly those employed in casinos and gaming establishments, are typically manufactured using coated paper or plastic composites designed for durability, shuffle-ability, and resistance to wear. However, these materials often lack recyclability and, once the cards are retired from use due to wear or the expiration of a gaming shoe, they are discarded. Current waste management practices for such materials largely involve landfill disposal or incineration, contributing to environmental pollution and resource depletion. This approach not only results in significant waste but also underutilizes the potential value of the materials embedded in used playing cards.

The hospitality industry, on the other hand, faces its own challenges related to waste generation, particularly from single-use tableware and packaging products. Single-use items such as plates, bowls, and platters are often constructed from non-biodegradable plastics or low-quality paper, which either contribute to environmental degradation or fail to provide sufficient durability for reuse. The environmental burden of such products is further amplified by the volume required to support the industry's operations, particularly in large-scale events, fast-food outlets, and other high-turnover dining establishments.

Efforts to reduce waste in the hospitality and gaming industries have encountered several limitations. In the gaming sector, while some initiatives focus on the reuse of playing cards through donations or repurposing for crafts and recreational activities, these efforts fail to address the bulk of discarded cards. Similarly, in the hospitality sector, advancements in biodegradable and compostable materials for tableware have seen limited adoption due to higher costs, limited performance in durability, and challenges with large-scale production.

Existing recycling systems also fall short when it comes to handling specialized materials like coated playing cards. The adhesives and coatings applied to enhance the cards'functionality complicate the recycling process, rendering conventional paper recycling methods ineffective. These materials often require specialized processing techniques, which are not economically viable or widely available, resulting in the continued reliance on disposal methods that exacerbate environmental problems.

Moreover, while automation and robotics have been extensively applied in manufacturing and waste processing, their implementation has rarely addressed the intersection of these two industries. Most automated waste management systems focus on large-scale recycling of standard materials such as plastics and metals but neglect the niche opportunities presented by repurposing composite materials like playing cards into value-added products.

In addition to environmental concerns, there are economic inefficiencies in the current lifecycle of playing cards and hospitality tableware. The gaming industry frequently incurs costs for the disposal of used cards, while the hospitality industry expends resources on procuring environmentally unfriendly single-use items. A system that bridges these gaps by reimagining waste as a resource has the potential to simultaneously address environmental, economic, and social concerns.

As global attention increasingly shifts toward sustainable practices, industries are compelled to explore innovative solutions for reducing waste and promoting circular economies. The challenges associated with handling used playing cards and single-use tableware present an opportunity for a novel approach to sustainability that addresses the overlapping concerns of these industries. By leveraging advancements in automation and material processing, it becomes possible to transform waste into functional, eco-friendly products, thereby redefining how resources are valued and utilized.

It is within this context that the present invention is provided.

### SUMMARY

The present invention relates to a system and method for processing planar material elements, such as playing cards, into molded structures suitable for use as tableware. The system incorporates a feeder mechanism, a manipulator assembly, a mold assembly, an adhesive dispensing assembly, a curing assembly, and a control system. These components are designed to operate in coordination, transforming planar materials into structured, bonded products. The invention aims to provide an automated process that efficiently repurposes materials while maintaining consistency and precision in manufacturing.

The system utilizes a robotic arm with a gripping mechanism to manipulate and arrange planar material elements into desired configurations. A mold assembly applies compressive force and, in conjunction with an adhesive dispensing system and a curing assembly, bonds the elements into a durable form. The process is governed by a control system, ensuring reliable and repeatable operation across varying material types and configurations. This approach addresses sustainability challenges in the reuse of composite materials and offers compatibility with a range of adhesive and molding technologies.

In some embodiments, the feeder mechanism includes a vibratory feeder to align planar material elements into a single-file configuration, allowing for orderly transfer to subsequent stages of the system. This ensures smooth operation and minimizes jamming or misalignment during processing.

In further embodiments, the robotic arm is equipped with a vacuum-based gripping assembly or a mechanical clamping system, allowing secure handling of materials with varying thicknesses and surface textures. This enhances the versatility of the system across different material compositions.

In yet further embodiments, the robotic arm is mounted on a linear rail system to facilitate horizontal movement, enabling the system to efficiently handle multiple stages of the process without requiring excessive workspace.

In some embodiments, the mold assembly includes heating elements embedded in the upper and lower mold dies to ensure uniform heating during compression. This promotes consistent bonding of the planar material elements and enhances the structural integrity of the final product.

In further embodiments, the adhesive dispensing assembly includes multiple precision nozzles to distribute adhesive uniformly across the material surfaces. This ensures proper bonding while minimizing adhesive waste.

In yet further embodiments, the curing assembly is configured to use heat, light, or ultrasonic energy to solidify the adhesive, providing compatibility with various adhesive formulations and improving the adaptability of the system.

In some embodiments, the system includes a staging platform with alignment guides and sensors to arrange planar material elements into a grid or other predefined patterns. This ensures that the materials are properly positioned for the molding process.

In further embodiments, the control system incorporates a machine vision module to verify the alignment and positioning of planar material elements. This enhances operational accuracy and reduces the likelihood of defects.

In yet further embodiments, the system includes a stacking assembly to organize and stack molded structures after curing. This feature streamlines the handling and packaging of finished products, increasing the efficiency of the overall process.

In some embodiments, the system includes a self-cleaning mechanism for removing residual adhesive from the mold surfaces and adhesive dispensing components, reducing downtime and maintaining product quality over extended periods of use.

In further embodiments, the planar material elements processed by the system are coated paper or plastic composites, such as used playing cards. This allows the system to repurpose non-recyclable materials, offering an environmentally friendly manufacturing solution.

In yet further embodiments, the adhesive applied by the system is a food-grade adhesive suitable for producing food-contact surfaces, enabling the system to manufacture products compliant with food safety standards.

### BRIEF DESCRIPTION OF THE DRAWINGS

Various embodiments of the invention are disclosed in the following detailed description and accompanying drawings.

FIG. 1A illustrates an example perspective view of the automated assembly line system for processing planar material elements into molded structures.

FIG. 1B illustrates an example side view of the automated assembly line system.

FIG. 1C illustrates an example top-down view of the automated assembly line system.

FIG. 2 illustrates an example curing station used in the automated assembly line system.

FIG. 3 illustrates an example top view of an injection mold unit for shaping planar material elements.

FIG. 4 illustrates an example side view of a robotic arm configured for material handling in the assembly line system.

FIG. 5 illustrates an example playing card dispenser used to stage planar material elements for retrieval by the robotic arm.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

The term “planar material element” refers to any substantially flat, thin structure capable of being arranged, manipulated, and bonded into a molded configuration. This includes, but is not limited to, paper materials, coated card stock, polymer composites, and laminates. In one example implementation, the planar material elements may be used playing cards constructed from coated paper or plastic materials with a thickness ranging from 0.2 mm to 1.0 mm.

The term “feeder mechanism” refers to any apparatus configured to receive, organize, and deliver planar material elements for subsequent processing. This includes, but is not limited to, vibratory feeders, conveyor systems, and magazine-style dispensers. In one example implementation, the feeder mechanism may be a vibratory feeder that utilizes oscillations to align playing cards into a single-file arrangement before transferring them to the manipulator assembly.

The term “manipulator assembly” refers to any system capable of transferring planar material elements from one location to another, while optionally arranging them into specific configurations. This includes, but is not limited to, robotic arms, gantry systems, and linear actuators. In one example implementation, the manipulator assembly may be a six-axis robotic arm equipped with a vacuum-based gripping mechanism for securely handling individual cards without damaging their surfaces.

The term “mold assembly” refers to any structure capable of receiving planar material elements, applying compressive force, and shaping the elements into a desired form. This includes, but is not limited to, molds with fixed or interchangeable dies and molds with integrated heating or curing elements. In one example implementation, the mold assembly may consist of upper and lower dies, each embedded with heating elements capable of reaching temperatures between 100° C. and 200° C., suitable for activating a thermosetting adhesive.

The term “adhesive dispensing assembly” refers to any device or system configured to apply an adhesive to planar material elements before or during the molding process. This includes, but is not limited to, nozzle-based dispensers, spray systems, and roll-on applicators. In one example implementation, the adhesive dispensing assembly may utilize precision nozzles to apply a food-grade adhesive, such as an aqueous polyvinyl acetate (PVA) solution, in a uniform layer across the material surfaces.

The term “curing assembly” refers to any component or system configured to solidify the adhesive applied to the planar material elements. This includes, but is not limited to, assemblies utilizing heat, ultraviolet light, or ultrasonic energy.

The term “control system” refers to any hardware or software arrangement configured to coordinate the operation of the various components of the system. This includes, but is not limited to, programmable logic controllers (PLCs), microcontrollers, and computer-based control systems. In one example implementation, the control system may be a PLC programmed with a machine vision algorithm for verifying the alignment of planar material elements before they are transferred to the mold assembly.

The term “gripping mechanism” refers to any device or structure attached to the manipulator assembly that enables the secure handling of planar material elements. This includes, but is not limited to, vacuum-based grippers, mechanical clamps, and electroadhesive pads. In one example implementation, the gripping mechanism may utilize suction cups made of silicone rubber to handle materials with a smooth or coated surface

The term “food-grade adhesive” refers to any adhesive formulation approved for contact with food surfaces under applicable regulatory standards, such as those set by the FDA or EU food safety regulations. This includes, but is not limited to, aqueous-based adhesives, thermosetting resins, and UV-curable adhesives. In one example implementation, the adhesive may be a water-based acrylic dispersion formulated to meet FDA 21 CFR 175.105 requirements for indirect food contact.

### DESCRIPTION OF DRAWINGS

The present invention relates to a system and method for processing planar materials, such as playing cards, into molded structures suitable for use as food-grade tableware. The invention combines automation, material bonding, and forming technologies to create an efficient process for repurposing materials that would otherwise contribute to waste streams. The system addresses significant shortcomings of prior art in both material recycling and single-use tableware production, offering a novel approach to sustainability and resource utilization.

In the gaming industry, used playing cards are frequently discarded after their functional life, leading to significant waste due to the composite materials and coatings that render them difficult to recycle. Similarly, in the hospitality industry, single-use tableware is often made from non-biodegradable plastics or low-quality paper, contributing to environmental degradation. The present invention bridges these two issues by transforming discarded planar materials, such as used playing cards, into functional tableware products, providing both an environmental and economic solution to existing challenges.

Unlike existing methods that rely on shredding or conventional recycling, the invention utilizes an integrated automated system to repurpose planar materials without significant preprocessing. The use of a robotic manipulator to arrange the materials into predefined configurations ensures precision and minimizes manual intervention, enabling the process to operate at scale. By incorporating adhesive application and a controlled curing mechanism, the invention achieves robust bonding of the materials, resulting in durable and reliable molded structures suitable for practical use.

The invention also offers flexibility in material handling and end-product design. The system can accommodate a variety of planar material types, adhesive formulations, and molding shapes, making it adaptable to a range of applications. Furthermore, the process is designed to operate with minimal waste, as unused adhesive or misaligned materials can be efficiently collected and recycled within the system. By repurposing difficult-to-recycle materials into useful products, it promotes a circular economy and reduces reliance on virgin materials. Additionally, the automated nature of the system ensures cost-effectiveness, scalability, and consistency, making it suitable for deployment in industrial settings.

The invention is directed to an automated system and method for processing discarded planar materials, such as playing cards, into functional food-grade tableware. The design addresses limitations in existing recycling and manufacturing technologies by integrating robotic manipulation, adhesive bonding, and curing processes into a streamlined assembly line. The components and workflow are described in further detail below to elucidate their roles in achieving the objectives of the invention.

The system structure comprises a combination of interconnected components designed to operate cohesively under the control of a central programmable logic controller (PLC) or equivalent system. This controller synchronizes the feeder mechanism, robotic manipulator, mold assembly, adhesive application system, curing system, and stacking mechanism to ensure seamless and efficient operation. The system's modular architecture allows for easy adaptation and scalability based on production needs.

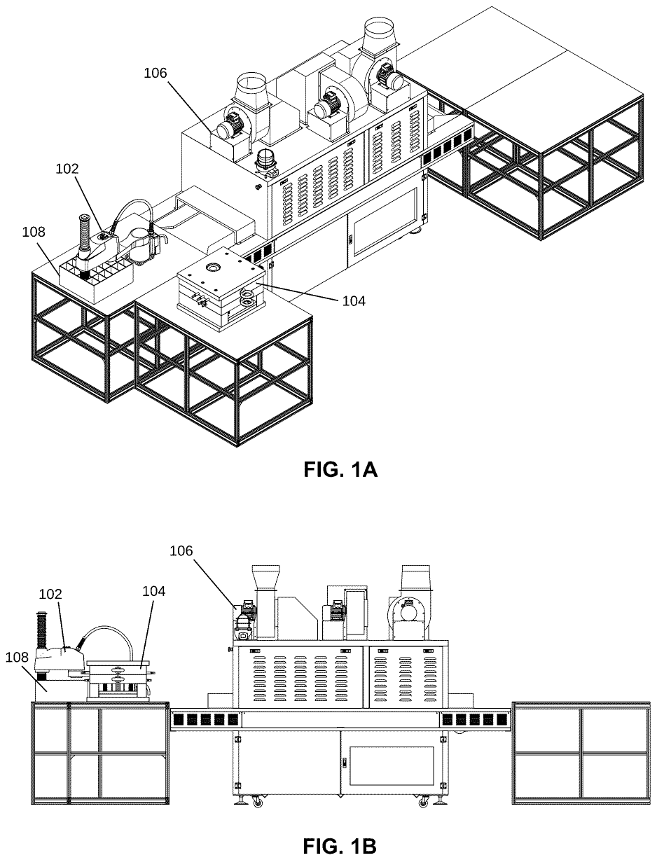

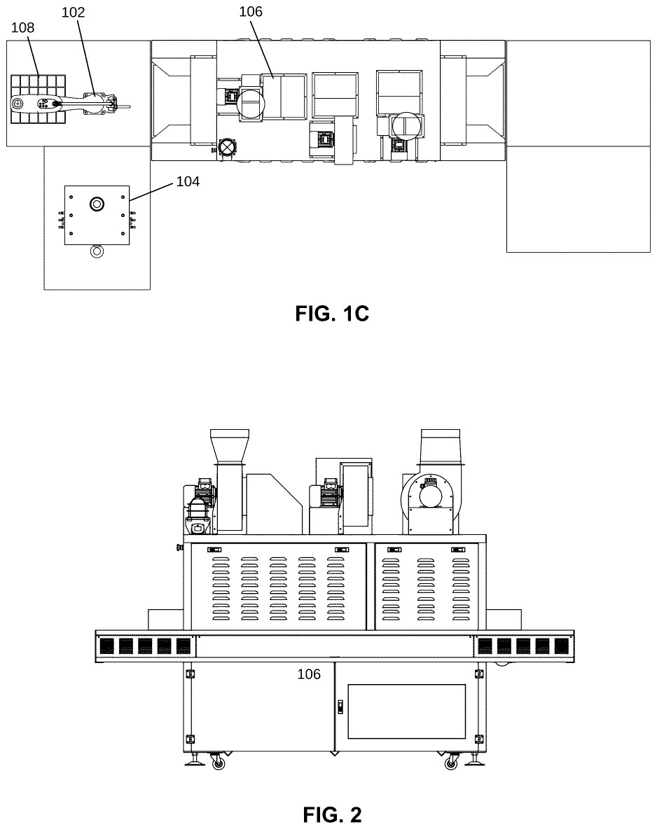

Referring now to the drawings FIG. 1A, FIG. 1B, and FIG. 1C illustrate perspective, side, and top-down views, respectively, of the automated assembly line system for processing planar material elements, such as playing cards, into molded structures like tableware. The assembly line is modular and consists of several interconnected machines, including a robotic manipulator assembly (102), a mold station (104), a curing station (106), and material infeed/outfeed stations (108).

Referring to FIG. 1A, the robotic manipulator assembly (102) is located at the leftmost section of the assembly line. This component includes a robotic arm mounted on a stationary base. The robotic arm is a multi-axis manipulator, such as a SCARA-type robot, configured to move horizontally and vertically to pick up, arrange, and transfer planar material elements. Attached to the robotic arm is a gripping mechanism, which may include vacuum suction cups or a mechanical clamping end-effector, allowing secure handling of the materials without causing surface damage. Adjacent to the robotic arm is a playing card dispenser, which serves as a staging platform where playing cards are pre-organized into slots or compartments for efficient retrieval and placement by the robotic arm. The manipulator operates in synchronization with downstream components, positioning the planar material elements accurately for subsequent processing.

Directly downstream of the robotic arm is the mold station (104), as shown in FIG. 1A and FIG. 1B. The mold station includes an upper mold die and a lower mold die, which are configured to press and shape the planar material elements into the desired form, such as a plate or bowl. The mold assembly is equipped with integrated heating elements or compression systems to activate the adhesive applied to the cards and to allow the cards to bond and retain the desired shape. The mold station rests on a supporting platform, providing structural stability to withstand the pressures exerted during the pressing operation.

Centrally positioned in the assembly line is the curing station (106), as prominently depicted in FIG. 1B and FIG. 1C. The curing station consists of an enclosed unit with ventilation ducts and exhaust systems integrated at the top. These components ensure controlled airflow, heating, or cooling to facilitate adhesive curing. The curing station may employ multiple curing methods, including thermal curing, UV light curing, or ultrasonic curing, depending on the type of adhesive used. Large fans or motors mounted on the top of the enclosure regulate temperature and airflow within the curing chamber. The curing station is modular, allowing for adjustments or integration of alternative curing technologies as needed.

The assembly line further includes material infeed and outfeed stations (108), positioned at the far-right end of the system, as shown in FIG. 1C. The infeed station serves as the entry point for raw materials, such as playing cards, which are loaded into the system for processing. The robotic manipulator assembly retrieves the cards from this station. The outfeed station serves as a collection area for finished molded products, such as plates or bowls, which are transferred from the curing station. The outfeed station may include a stacking platform or automated packaging system to organize the finished products for storage or transport.

The assembly line is supported by a conveyor path or processing frame that runs horizontally across the system. This frame provides the necessary support and alignment for transferring materials between stages of the process, ensuring seamless operation. Additionally, control or access panels are integrated along the central curing unit. These panels may house the programmable logic controller (PLC) or other control electronics that govern the operation of the robotic arm, mold station, curing unit, and material flow. The access panels allow for maintenance, troubleshooting, and adjustments to the system's parameters.

In FIG. 1C, a top-down view highlights the layout and relative positioning of the machines. The robotic arm (102) is seen adjacent to the playing card dispenser, ensuring efficient transfer of material into the mold station (104). The curing station (106) occupies the central portion of the system, and the material outfeed station (108) is positioned downstream to receive the final products. The modular design ensures that each machine operates in coordination under the control of a central system, optimizing the workflow and efficiency of the assembly line.

FIG. 2 illustrates a curing station (106) used in the automated assembly line system. The curing station consists of a large, rectangular central enclosure with multiple ventilation slots or louvers along the front face. These slots serve to regulate internal airflow and dissipate heat generated by the curing process. At the top of the enclosure, two prominent ducted exhaust systems with integrated motors and fans are visible. These ventilation units ensure the removal of heat, fumes, or excess air from the curing chamber, maintaining a controlled environment critical for adhesive curing. The side of the curing station includes lockable access panels, which provide maintenance personnel access to internal components, such as heating elements or curing mechanisms.

The curing station incorporates a forced-air system to ensure even heat or airflow distribution within the chamber, facilitating consistent curing of adhesives applied to the planar material elements. The station rests on a supporting frame with wheels or casters at the base, which enable repositioning or reconfiguration of the system during maintenance or system upgrades. Control electronics, housed within the lower section of the enclosure, regulate curing parameters such as temperature, airflow, and timing. These electronics interface with the assembly line's programmable logic controller (PLC) to ensure precise synchronization with upstream and downstream processes. The curing station plays a pivotal role in solidifying adhesives and setting the molded structures, ensuring the durability and quality of the final product.

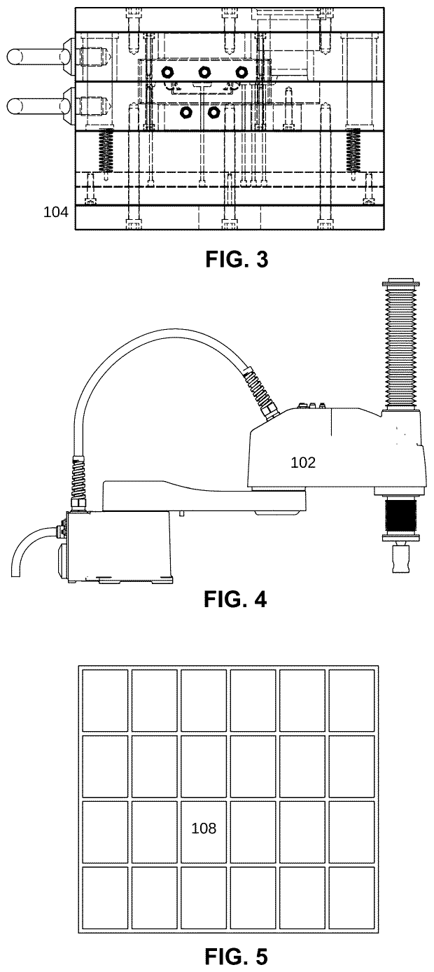

FIG. 3 presents a top-down view of an injection mold unit (104). The injection mold consists of multiple stacked plates, held together by structural bolts and fasteners to ensure a secure assembly. Guide pins positioned at the corners provide precise alignment during the opening and closing of the mold assembly. The central portion of the mold contains cavities and cores where the planar material elements are pressed and shaped into the desired form, such as tableware products like plates or bowls. These cavities are designed to accommodate the flow of adhesive or resin while ensuring even distribution.

Centrally located ejector pins or rods are visible, which assist in pushing the molded product out of the mold cavity once the pressing cycle is complete. The ejector pins are symmetrically arranged to ensure uniform force distribution and prevent deformation of the molded product during ejection. Coil springs positioned on either side of the mold assist in returning the ejector plate to its starting position, allowing the mold to reset for subsequent cycles. The mold assembly further includes small channels or gates, likely injection ports, which allow the adhesive or other bonding materials to enter the cavities. This combination of features ensures consistent molding, high reliability, and repeatable production of the desired product.

FIG. 4 provides a side view of the robotic arm (102), labeled as the FANUC SR-6iA/C, a SCARA-type robot. The robotic arm includes a stationary base section that houses motors, controllers, and wiring required to drive the robotic movements. The horizontally extending arm structure provides movement along the XY plane, allowing the robotic arm to reach, retrieve, and precisely position planar material elements. On the right side of the robotic arm, a Z-axis assembly is visible, featuring a telescopic or threaded component for vertical motion. This vertical mechanism enables the robotic arm to lift or lower objects, facilitating efficient material transfer.

At the bottom of the vertical assembly, the robotic arm includes an end effector, which may consist of a vacuum-based gripping system, suction cups, or a mechanical clamp. This end effector is configured to securely handle playing cards or similar planar material elements without damaging their surfaces. A flexible cable assembly extends from the robotic base to the upper portion of the arm, providing the necessary power and control signals while ensuring minimal interference with arm movements. The robotic arm's compact design, combined with its high-speed and repeatable motion capabilities, makes it ideal for automating tasks such as retrieving cards from a dispenser and placing them into a mold with precision.

FIG. 5 illustrates the playing card dispenser (108), which works in conjunction with the robotic arm. The dispenser features a grid layout consisting of a 5×6 matrix of compartments or slots, totaling 30 uniform slots. Each slot is sized and shaped to hold an individual playing card in a consistent and organized manner. This design ensures that the cards are evenly spaced and aligned, simplifying the robotic arm's retrieval process.

The slots are arranged to provide predictable and uniform spacing, which reduces the likelihood of card misalignment during pick-and-place operations. The dispenser serves as a staging area, where playing cards are preloaded and held in a predefined pattern before being transferred into the next processing stage. The robotic arm retrieves cards directly from the grid, ensuring an efficient and repeatable operation. The dispenser is likely constructed from a durable, low-friction material such as plastic or aluminum, allowing the cards to slide in and out smoothly without tearing or damage.

The placement of the dispenser adjacent to the robotic arm optimizes the workflow by minimizing the distance the robotic arm must travel, improving operational efficiency. This component plays a critical role in the automated assembly line, as it enables consistent and orderly card handling, facilitating accurate placement into the mold assembly for subsequent processing.

The feeder mechanism serves as the entry point for planar materials into the system. It is configured to collect playing cards or similar planar elements, align them, and feed them to the manipulator assembly. In one embodiment, a vibratory feeder is employed to organize cards into a single-file stream. Sensors integrated into the feeder mechanism ensure that any misaligned or improperly fed cards are redirected, maintaining a smooth operation and reducing system downtime.

The robotic manipulator, a multi-axis robotic arm, retrieves aligned cards from the feeder mechanism and arranges them into a predefined pattern. Equipped with a vacuum-based gripping system or, optionally, a mechanical clamp, the manipulator ensures secure handling of the cards. Its precision movements are guided by control algorithms that consider variables such as card size, weight, and surface texture. The manipulator operates on a linear rail to maximize its range of motion, ensuring that it can interface with various system components without increasing the system's footprint.

Before transferring the cards to the mold, the manipulator arranges them on a staging platform, where alignment guides and sensors verify their placement in a predefined configuration. This intermediary step ensures accurate arrangement for subsequent molding operations, minimizing errors and reducing material waste.

The mold assembly receives the arranged cards and applies compressive force to shape them into the desired tableware configuration. The mold assembly includes upper and lower dies equipped with integrated heating elements capable of reaching temperatures sufficient to activate the adhesive and soften the materials. The mold is designed to accommodate interchangeable dies, enabling the production of various tableware shapes, such as plates, bowls, or platters, from the same system.

An adhesive application system is positioned proximate to the mold assembly. This system applies a uniform layer of food-grade adhesive to the cards before or during the molding process. In one embodiment, precision nozzles distribute the adhesive, with sensors monitoring application consistency. The adhesive formulation may vary based on the desired curing method, with examples including thermosetting resins for heat curing and UV-curable adhesives for light-based curing.

The curing system solidifies the adhesive to form a durable bond between the cards. In some embodiments, the curing process utilizes heat, supplied by the mold assembly's embedded elements, to activate thermosetting adhesives. Alternatively, UV curing systems or ultrasonic energy may be employed, depending on the adhesive's specific requirements.

After curing, the mold opens, and the robotic manipulator transfers the finished tableware product to a stacking station. Here, the products are organized into neat stacks, which are subsequently wrapped for sale or transport. The stacking station is equipped with an automated quality control system, which inspects each product for defects before packaging.

The system incorporates a waste management sub-system that collects excess adhesive, misaligned cards, and other by-products for recycling or disposal. Self-cleaning mechanisms in the adhesive nozzles and mold surfaces maintain operational consistency and reduce downtime associated with maintenance.

The invention addresses the shortcomings of prior systems by integrating all essential processes—material handling, adhesive application, shaping, and curing—into a single automated assembly line. The modular nature of the system supports easy adaptation to various planar materials and product designs, while its reliance on automation minimizes human intervention, reducing labor costs and operational inefficiencies. By enabling the reuse of discarded materials like playing cards, the system provides a sustainable manufacturing solution that aligns with the growing demand for environmentally conscious production methods.

### Controller/Processor Components

A processor or controller as described herein may include any suitable type of computing device, such as a central processing unit (CPU), microcontroller, graphics processing unit (GPU), system on a chip (SoC), or digital signal processor (DSP). It may operate with one or more cores and may be configured to execute the functions described in this disclosure.

The processor may be operably connected to one or more memory devices, such as random access memory (RAM), read-only memory (ROM), flash storage, or solid-state drives (SSD). These memory devices store computer-readable instructions that, when executed by the processor, perform the methods described. The processor and memory communicate via data buses or other suitable communication pathways.

The computing device may also include input/output (I/O) devices, such as a touchscreen, mouse, keyboard, display, or speaker, to facilitate interaction with users or other systems. Additionally, it may include a network interface, such as a wired or wireless communication module, for connecting to networks.

Control logic or software instructions may be stored in memory and executed by the processor to implement specific functionalities. This logic may be modular, consisting of software components, processes, or functions that work together to perform the operations described herein.

The described computing operations involve the manipulation of data represented as electrical, optical, or magnetic signals stored or transferred within the system. These operations are machine-executed and do not require manual intervention, though they may interface with human operators through appropriate user interfaces.

The systems and methods described are not limited to any particular hardware configuration or programming language and may be implemented on general-purpose or specialized computing devices.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the ... of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for processing planar materials into molded structures, comprising:
a. a feeder mechanism configured to receive and align individual planar material elements in a predefined arrangement;
b. a manipulator assembly operatively connected to the feeder mechanism, the manipulator assembly comprising:
i. a multi-axis robotic arm, and
ii. a gripping mechanism coupled to the robotic arm, the gripping mechanism being configured to releasably secure one or more of the planar material elements;
c. a mold assembly positioned downstream of the feeder mechanism, the mold assembly comprising:
i. a mold structure configured to receive the planar material elements in an arranged configuration, and
ii. a press mechanism associated with the mold structure and configured to apply compressive force to the planar material elements;
d. an adhesive dispensing assembly positioned proximate to the mold assembly, the adhesive dispensing assembly being configured to apply an adhesive to at least a portion of the planar material elements prior to or during compression within the mold structure;
e. a curing assembly operatively connected to the mold assembly, the curing assembly being configured to solidify the adhesive applied to the planar material elements; and
f. a control system operatively connected to the feeder mechanism, the manipulator assembly, the mold assembly, the adhesive dispensing assembly, and the curing assembly, the control system being configured to coordinate the operation of the components to produce a molded structure.

2. The system of claim 1, wherein the feeder mechanism comprises a vibratory feeder configured to arrange the planar material elements into a single-file configuration before transferring them to the manipulator assembly.

3. The system of claim 1, wherein the gripping mechanism comprises a vacuum-based gripping assembly having one or more suction cups formed from a flexible, wear-resistant material.

4. The system of claim 1, wherein the gripping mechanism further comprises a mechanical clamping assembly configured to secure planar material elements of varying thicknesses.

5. The system of claim 1, wherein the robotic arm is mounted on a linear rail system enabling horizontal translation along the length of the system.

6. The system of claim 1, wherein the mold structure comprises an upper mold die and a lower mold die, each die including embedded heating elements configured to apply heat during the compression of the planar material elements.

7. The system of claim 1, wherein the adhesive dispensing assembly comprises a plurality of precision nozzles configured to distribute adhesive uniformly across the planar material elements.

8. The system of claim 7, wherein the adhesive dispensing assembly includes an adhesive reservoir and a monitoring sensor configured to detect adhesive levels and signal replenishment when necessary.

9. The system of claim 1, wherein the press mechanism of the mold assembly is pneumatically or hydraulically actuated.

10. The system of claim 1, wherein the curing assembly is configured to utilize at least one of heat, light, or ultrasonic energy to solidify the adhesive.

11. The system of claim 10, wherein the curing assembly comprises ultraviolet light sources configured to activate an ultraviolet-curable adhesive.

12. The system of claim 1, further comprising a staging platform positioned between the feeder mechanism and the mold assembly, the staging platform being configured to arrange the planar material elements into a grid pattern.

13. The system of claim 12, wherein the staging platform comprises alignment guides and optical sensors to ensure proper positioning of the planar material elements.

14. The system of claim 1, wherein the control system is programmed with a machine vision module configured to verify alignment and positioning of the planar material elements during operation.

15. The system of claim 1, wherein the planar material elements are coated paper or plastic composite materials.

16. The system of claim 1, further comprising a stacking assembly positioned downstream of the curing assembly, the stacking assembly being configured to organize and stack the molded structures into a predefined arrangement.

17. The system of claim 16, wherein the stacking assembly comprises a secondary robotic manipulator configured to retrieve molded structures from the curing assembly and deposit them in a packaging area.

18. The system of claim 1, further comprising a self-cleaning mechanism configured to remove residual adhesive from the mold structure and adhesive dispensing assembly.

19. The system of claim 1, wherein the adhesive is a food-grade adhesive suitable for producing food-contact surfaces.

20. The system of claim 1, wherein the planar material elements are playing cards.
